(19) United States
(12) Patent Application Publication
(10) Pub. No.: US 2005/0165649 A1
(43) Pub. Date: Jul. 28, 2005

(54) Accessible shopping guide for retail business

(75) Inventors: Robert Bruce Mahaffey, Austin, TX (US); Samuel Roy Detweiler, Cedar Park, TX (US); Karen Elizabeth Kistler, Pflugerville, TX (US)

Correspondence Address: Gregory W. Carr;670 Founders Square, 900 Jackson Street, Dallas, TX, 75202, US

(73) Assignee: International Business Machines Corporation, Armonk, NY (US)

(21) Appl. No.: 10/763,107

(22) Filed: Jan. 22, 2004

(51) Int. Cl. G06F 17/60

(52) U.S. Cl. 705/26

(57) ABSTRACT

An accessible shopping guide to a retail business. A shopper generates a shopping list by interaction with a website of the retail business accessible by persons with cognitive disabilities. During the interaction, the server connected to the website can suggest retail products or utilize information about the shopper.

### TECHNICAL FIELD

The invention relates generally to computer systems and, more particularly, to computer systems that perform customer service functions in connection with retail stores.

### BACKGROUND

The information provided to a shopper is important to the quality of his shopping experience. In recent years, on-line shopping has become a popular alternative to shopping in stores or through mail-order catalogs. Many shoppers appreciate the convenience of viewing product information and placing orders via their home computers. Nevertheless, retail shopping still presents many advantages over on-line shopping. Shoppers can view and handle items for purchase; they can purchase them and take them home immediately, or even consume them on the spot; they can obtain advice from knowledgeable sales staff, and they can enjoy the social experience of retail shopping.

The in-store shopping experience may be planned by the retailer to expose the shopper to as many buying opportunities as possible. Traversing an aisle in a grocery store may take the shopper past thousands of different items. This may present a cognitive overload for the person with cognitive limitations, such as some senior citizens, persons with attention deficit or memory problems, or other learning disabilities. The resulting shopping experience can be confusing, frustrating, and unpleasant for the shopper.

Because many brick-and-mortar retailers now have on-line catalog operations, it is possible for these shoppers to browse the on-line catalog, find one or more items they are interested in, and then travel to the nearest retail store of the proprietor of the on-line catalog to examine and then purchase items found through the on-line catalog. This practice may combine some of the best aspects of on-line and in-person shopping, since perusing the on-line catalog may be much more efficient than walking around the retail store to look for products of interest. However, even when the shopper arrives at the retail store knowing which product or products he may wish to buy, based on a perusal of the on-line catalog, the shopper is still faced with the problem of finding the product of interest in the retail store. With the very large size of some retail establishments, a considerable amount of time may be spent attempting to find the products in which the shopper is interested. Inquiries of store personnel as to the locations of products may not be of great assistance, since many store employees are recent hires who may not be familiar with product locations, and store employees may not be easy to locate, or may be in great demand.

The provision of sales information to shoppers also presents an opportunity to make additional sales, by informing the shopper of products that he might not know about or might forget. Many retail stores collect information about the shopping habits of shoppers; for example, through the issuance of loyalty cards. The stores could make use of the information to suggest purchases.

Some shoppers are persons with disabilities. Some may need special accessibility accommodations at the retail store. Others may need information provided to them in cognitively accessible form.

A kiosk can be provided in a retail store, where the kiosk displays a menu of items available for sale in the store. When a shopper selects an item from the menu, the kiosk displays information indicative of the location of the item in the store.

A floppy disk can be made available at a retail store, which contains a list of items available at the store and their respective aisle locations. A shopper obtains a copy of the disk. The list of items is retrieved from the disk and displayed on a personal computer used by the shopper. The shopper selects items from the list. The computer then prints a store map showing the locations of the selected items.

A shopper can be guided to a product available for sale in a retail store. The method includes the shopper entering at least one product code and retrieving product location information for at least one product corresponding to the entered at least one product code. The method further includes presenting the retrieved product information location to the shopper. The product location information may include a walking route map to the location of the product, or may include the number of an aisle in which the product is located.

When the shopper has a portable computing device, the method includes the shopper uploading a shopping list to a website server, which might contain information about the quantity desired of at least one item on the list. The server then downloads information to the portable computing device. The downloaded information might indicate that an item on the shopping list is not available and might indicate an alternative to an item that is not available. The downloaded information might state whether an item on the shopping list is for sale, or whether one brand is cheaper than another brand. The downloaded information might include the quantity desired of at least one item on the list. The presentation of the downloaded information might include printing the shopping list with the quantity of at least one item.

One version of the method includes the selection of a product from an on-line catalog, retrieving product location information about the selected product, and presenting the retrieved product location information.

These three methods of providing location information about items in a retail store have drawbacks. In all of the methods, the shopper must generate a shopping list by other methods. Further, the shopper must search elsewhere to find information other than location information, such as which products are available in the store, their cost, and their description. In the first method, the shopper must go to the retail store to obtain the information. The trip may be wasted, since essential items for the shopper might not be available at the store. In the second method, the information is soon outdated. The location information could be changed within hours after the shopper has brought home the computer disk with location information. In one version of the third method, where the shopper first shops from an on-line catalog, he may select a product only to find that it is not available in the retail location he is interested in. In addition, the shopper may be overwhelmed by the choices presented, from the total inventory of the retail business.

None of the methods provide a retail business with the opportunity of suggesting items to a shopper, except the last method, and then only when the shopper has accessed the website server through a portable computing device. None of the methods make use of information about the shopper to suggest items to a shopper.

Therefore, there is a need for an accessible shopping guide for retail stores so that shoppers can, in one step, without driving to a retail store or visiting multiple websites, obtain complete, up to date information about products, generate a shopping list, select a suitable retail location, and be presented with a shopping guide.

### SUMMARY OF THE INVENTION

The present invention provides an accessible shopping guide for shoppers of a retail business. Shoppers access a website to generate a shopping list and obtain product information, including information about the location of a product in a retail store associated with the retail business.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 illustrates a block diagram of computer equipment employed to generate and present an accessible shopping guide;

FIG. 2 illustrates a block diagram presenting a more detailed view of the data bases accessible through the server;

FIG. 3 illustrates a flow diagram of the generation and presentation of a shopping guide;

FIG. 4 illustrates a flow diagram of the generation of a shopping list;

FIG. 5 illustrates a flow diagram for generating a shopping list in accordance with an alternative aspect of the invention; and

FIG. 6 illustrates a flow diagram of two aspects of presenting the shopping guide to a shopper; in FIG. 6A, the guide is presented by printing from the desktop computer of the shopper; in FIG. 6B, the guide is downloaded to a computer kiosk at the retail store, the shopper identifies himself, and retrieves the shopping guide from the kiosk.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

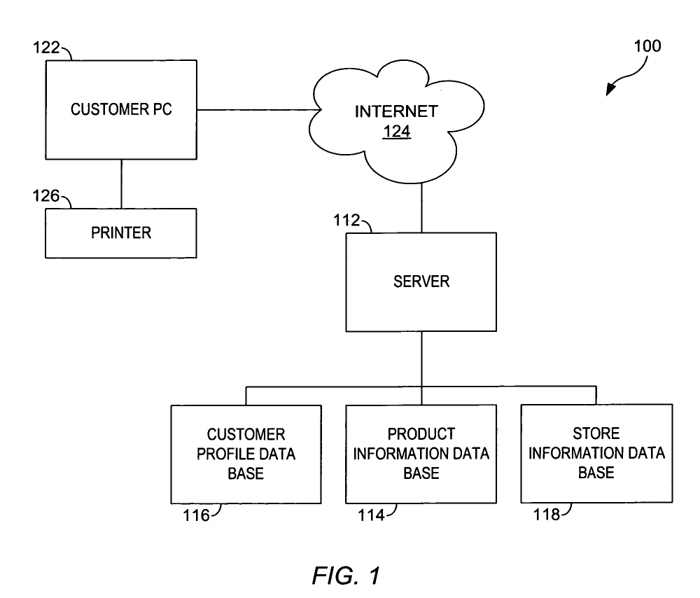

Turning to FIG. 1, disclosed is a computer system 100 for generating and presenting an accessible shopping guide. Shoppers access the system to obtain in one step complete, up to date information about products, generate a shopping list, select a suitable retail location, and be presented with a shopping guide. During the interaction, the system can suggest items of potential interest to the shoppers, and can make use of information about the shoppers, when available.

The system 100 includes a conventional web server 112. The server 112 has access to a collection of data bases about a retail business, a chain or a single location. The data bases include a product information data base 114, a store information data base 118, and a customer profile data base 116.

The product information data base 114 stores information regarding products available for sale in the retail stores of the retail business. The store information data base 118 stores data regarding store locations, locations of products within the store, and other information concerning the stores operated by the retail business. The customer profile data base 116 stores information about customers of the retail business.

A personal computer (PC) 122 is connected to the server 112 via the Internet 124. In one embodiment, the personal computer 122 connects to the server 112 through the Internet by accessing a website served by the server 112. The PC 122 can be located at the home of a shopper. A printer 126 is associated with the PC 122. Alternatively, the shopper can connect to the server via a portable computing device.

In one embodiment, the web server 112 is accessible to persons with disability, including people with low vision, people with reading difficulties, and people with memory disorders or other cognitive deficiencies. At the option of the user, the website is cognitively accessible. The website display uses large fonts and large, clear graphics; displays pictures of products where available; uses color combinations of text vs. background for easy reading; and provides adequate white space between lines of text and between words. Distracting graphics, including anything flashing, and extraneous information are removed from the website. The website avoids pulldowns or other techniques that put demand on the memory of the shopper, and avoids icons that might have no meaning. The output is suitable for reading by a text to speech device, if the customer so desires.

The components of the system 100 enable a shopper to generate a shopping list and obtain product information and location information all in one step. The system is connected to data bases containing all of the required information. Further, the system enables the retail business to suggest items to the shopper, and to utilize customer profile information. Since the shopper interacts with the system 100 to produce a shopping list, it is easy for the system 100 to suggest items during the interaction. Since the system 100 has access to the customer profile data base 116, it can utilize the data stored therein while suggesting items.

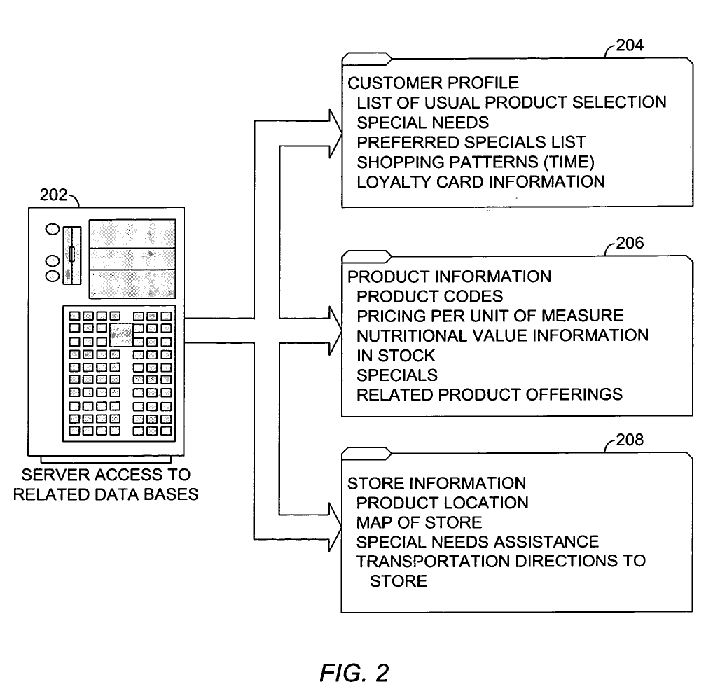

Turning now to FIG. 2, disclosed is more detail about the information stored in the data bases depicted in FIG. 1. In one embodiment, the customer profile data base 204 contains a list of the usual product selection of the shopper, his special needs, his preferred specials list, his shopping patterns over time, and information from use of the loyalty card of the retail business. The product information data base 206 contains product codes, price, price per unit of measure, nutritional value information, which stores have the item in stock, specials, and related product offerings. The store information data base 208 contains a map of the store, the location of each product in the store, information about special needs assistance, and transportation directions to the store.

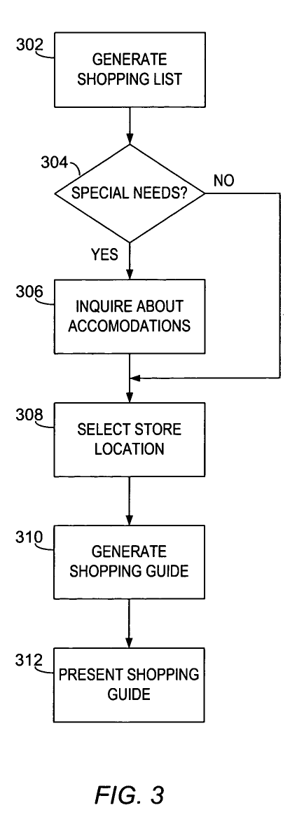

FIG. 3 illustrates a flow diagram of the process of the generation and presentation of a shopping guide. In step 302, a shopping list is generated in an interaction between the shopper and the server 112. In one embodiment, the shopper interacts with the server 112 through his PC 122. In step 304, the shopper inputs whether he has special needs. If so, in step 306, he inquires about available accommodations. If not, he goes directly to step 308. Next, in step 308, in one embodiment, once the shopping list is generated, a store location is selected. In one embodiment, the server suggests locations, based upon the items making up the shopping list, their availability in retail stores of the retail business, and proximity to the shopper. The server accesses the store information data base to determine store locations and product availability. In an alternative embodiment, the shopper can specify the store location before generating the shopping list or during the generation of the shopping list.

In step 310, the shopping guide is generated. In one embodiment, the shopper specifies which features of the items making up the shopping list are to be included. The server then accesses the product information data base 114 to obtain information about the items making up the shopping list and the store information data base 118 to obtain information about the location of the items. The server then incorporates the information into a shopping guide. The product location information can be presented in several forms. For example, the product location information can be the number of an aisle at which the product is located in the store. Alternatively, the product location information can take the form of a map of the retail store in question, with the map having highlighted notations to indicate the locations of the products within the store. The map can indicate a walking route within the store that will guide the shopper to the respective locations of the items making up the shopping list that the shopper is interested in.

In one embodiment, the shopping guide begins by welcoming the shopper to the selected retail location. It provides driving instructions, if needed, and suggests the best times to shop. It provides the shopper with a list of the items making up the shopping list, with the information requested by the shopper. It provides the shopper with a route through the store that goes past the items on the shopping list, and also goes past other items that the shopper typically purchases, unless the shopper specifies that he is in a hurry. In that case, the shopping guide provides the shopper with the most direct route through the store past all of the items on the shopping list. The shopper can elect to receive advice on the unit price of items, and on what size is the best buy. The shopping guide also includes special items such as sale items or seasonal items and items that the customer usually purchases. It also mentions special events occurring in the store. The shopper can select an option not to be informed of special items and special events. This option is particularly useful to the cognitively impaired.

In step 312, the information in the shopping guide is presented to the shopper. The presentation of the information benefits both the shopper and the retail business. It increases shopper satisfaction with the shopping experience, and thereby increases his loyalty to the retail business.

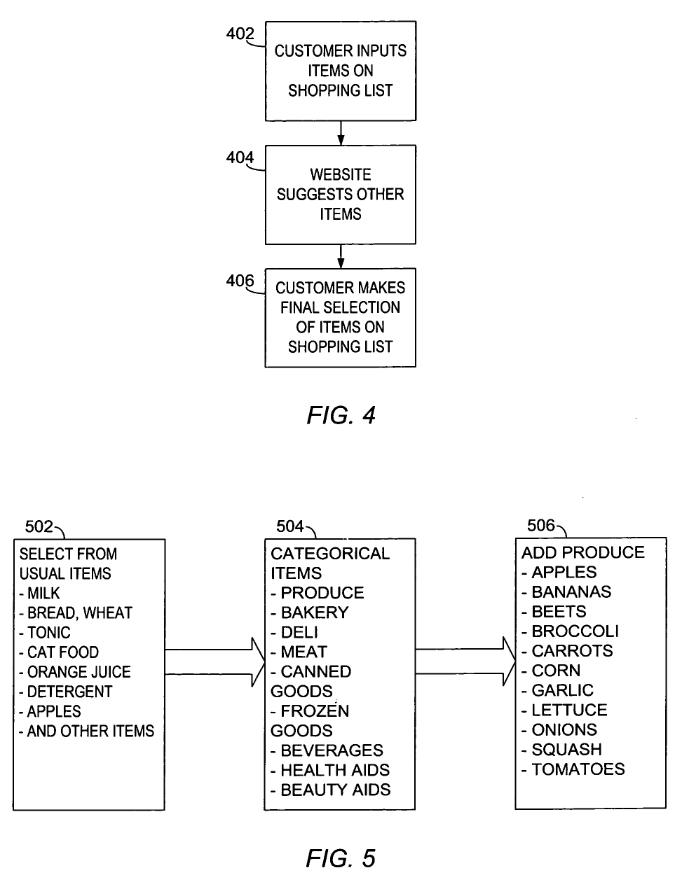

FIG. 4 presents a more detailed drawing of the process of generating the shopping list by an interaction between the shopper and the server. In step 402, the shopper inputs items on a shopping list. In step 404, the server suggests other items. In one alternative embodiment, the server accesses the customer profile data base 116 to suggest additional items. In one alternative embodiment, the server queries the shopper about his shopping habits and preferences. In one alternative embodiment, the server recommends products that are associated with products that the shopper has listed. For example, if the shopper places beer on the shopping list, the server can suggest pretzels. In one alternative embodiment, the server accesses the product information data base 114 to recommend special items, items that are not normally available, or are not available on the same terms. Included could be seasonal items, sale items, and special purchases. In step 406, the shopper makes a final selection of the items on the shopping list.

FIG. 5 presents a more detailed drawing of the process of the shopper inputting items on the shopping list. In one alternative version, in step 502 the server first presents to the shopper a list of his usual purchases, for selection. The server obtains the list by accessing the customer profile data base 116. Next, in step 504, the server presents the shopper with categories of products. Once the shopper chooses a category, in step 506, the server presents the shopper with subcategories of the category for selection. In an alternative version, the server could present an alphabetical listing of products. In an alternative version, the server could let the shopper type in search terms for products. In an embodiment where the shopper selects a retail location before generating the shopping list, the interaction is confined to products in the selected location. The shopper is not overwhelmed by the complete listing of all products offered by the retail business, and the interface is faster. Less data has to pass over the Internet. If a retail product is unavailable at that location, the shopper can inquire about other locations.

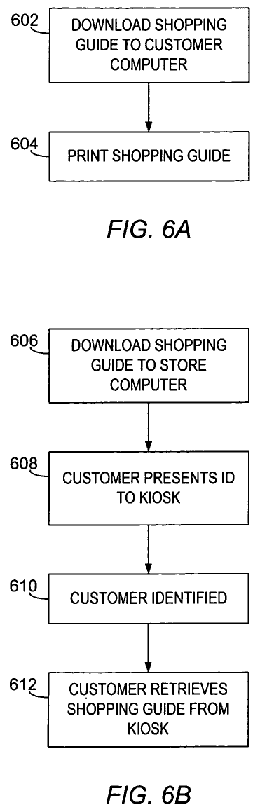

FIG. 6 presents two alternative methods of presenting the shopping guide to the shopper. In FIG. 6A, in step 602, the shopping guide is downloaded to a personal computer 122. In step 604, the information is printed out on a sheet of paper by the printer 126, which is connected to the personal computer 122. In FIG. 6B, in step 606 the shopping guide is downloaded to a store computer. In step 608, the shopper presents identification at a kiosk. This can be done, for example, by swiping a credit card or a magnetic stripe identification card issued by the store through a card reader located at the kiosk. Alternatively, the shopper can enter alphanumeric information via an input device located at the kiosk, or can present identification to an employee. In step 610, the shopper is identified on the basis of the shopper identification information that was entered at step 608. Then, at step 612, the store computer retrieves the shopping guide that was entered into the computer prior to the shopper visiting the store. The shopping guide is presented to the shopper, for example, by printing it out. In an alternative embodiment, the customer can retrieve the shopping guide at a service counter in the store.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A system for providing a shopping guide to shoppers of a retail business, comprising:
a website;
a server interconnected to the website; and
a presentation means coupled to the server, configured to have specifications for retail products input through the website;
wherein the server is configured to pass product information and retail store information, including product location information about the specified retail products to the presentation means; and
wherein the presentation means is configured to present a shopping guide which includes the product information and the retail store information, including the product location information.

2. The system of claim 1, further comprising a
retrieval means coupled to the server, wherein the server is further configured to obtain from the retrieval means product information and retail store information, including product location information, about the specified retail products.

3. The system of claim 2, wherein the website is accessible by persons with disabilities.

4. The system of claim 2, wherein the website is further configured to receive customer identification information from the shopper and the server is further configured to obtain from the retrieval means customer profile information about the person identified by the customer identification information.

5. The system of claim 2, wherein the server is further configured to interact with the shopper through the website and wherein the server is further configured to request demographic information and shopping habit information from the shopper.

6. The system of claim 5, wherein the server is further configured, responsive to the demographic information and shopping habit information requested by the server, to obtain product information and retail store information, including product location information.

7. The system of claim 2, wherein the server is further configured to reference in the shopping guide a retail product not specified by the shopper.

8. The system of claim 2, wherein the server is further configured to interact with the shopper through the website and the server is further configured to reference a retail product not specified by the shopper.

9. The system of claim 2, wherein the server is further configured to interact with the shopper through the website, and wherein the server is further configured for the shopper to select a retail location of the retail business through the interaction.

10. The system of claim 9, wherein the server is further configured to obtain information about an event occurring at the retail location.

11. The system of claim 2, wherein the server is further configured to obtain information about retail store locations from the retrieval means; and wherein the server is further configured to include information about one or more retail store locations for the shopper in the shopping guide.

12. The system of claim 2, wherein the server is further configured to interact with the shopper through the website; and wherein the server is further configured to reference one or more retail store locations for the shopper during the interaction.

13. The system of claim 2, wherein the system further comprises a retail store map generating means for generating a retail store map route in response to input from the shopper.

14. The system of claim 13, wherein the retail store map generating means is further configured to be responsive to other data as well as to the input from the shopper.

15. The system of claim 2, wherein the website is configured to be accessed through a personal computer.

16. The system of claim 2, wherein the presenting means consists of a computer kiosk in the retail store outlet.

17. The system of claim 2, wherein the presenting means consists of a customer service desk in the retail store outlet.

18. The system of claim 2, wherein the website is configured to be accessed through a portable computing device.

19. The system of claim 18, wherein the presenting means consists of downloading to the portable computing device.

20. A method for providing a shopping guide to a shopper of a retail business, comprising the steps of:
interacting between a shopper and a website of the retail business;
generating a shopping list through the interaction;
selecting a retail location of the retail business;
generating a shopping guide for the shopping list and the retail location, which shopping guide includes product location information about the items on the shopping list; and
presenting the shopping guide to the shopper.

21. The method of claim 20, generating the shopping list by the interaction of the shopper with an accessible website of the retail business.

22. The method of claim 20, generating the shopping guide with the employment of customer profile information about the shopper.

23. The method of claim 20, wherein the interacting between the shopper and the website further comprises the step of requesting demographic information and shopping information from the shopper.

24. Computer program product for providing a shopping guide to a shopper of a retail business, the computer program product having a medium with a computer program embodied thereon, the computer program comprising:
computer code for interacting between a shopper and a website of the retail business;
computer code for generating a shopping list through the interaction;
computer code for selecting a retail location of the retail business;
computer code for generating a shopping guide for the shopping list and the retail location, which shopping guide includes product location information about the items on the shopping list; and
computer code for presenting the shopping guide to the shopper.

25. The computer program product of claim 24, wherein the computer code is for generating the shopping list by the interaction of the shopper with an accessible website of the retail business.

26. The computer code product of claim 24, wherein the computer code is for generating the shopping guide with the employment of customer profile information about the shopper.
